(19) United States
(12) Patent Application Publication
(10) Pub. No.: US 2018/0073295 A1
(43) Pub. Date: Mar. 15, 2018

(54) COMPOSITE LADDER TAPE AND WINDOW BLIND WITH THE SAME

(71) Applicant: NIEN MADE ENTERPRISE CO., LTD., Taichung (TW)

(72) Inventor: KENG-HAO NIEN, Taichung (TW)

(21) Appl. No.: 15/403,609

(22) Filed: Jan. 11, 2017

(30) Foreign Application Priority Data
Sep. 14, 2016 (CN) 201621054750.8

(51) Int. Cl. E06B 9/382

(52) U.S. Cl. CPC E06B 9/382

(57) ABSTRACT

A window blind includes a headrail, a bottom rail, a plurality of slats horizontally provided therebetween, and a composite ladder tape, which includes a first warp and a second warp respectively provided on a front side and a rear side of the slats, a plurality of wefts arranged in a long axis direction of the first warp and a long axis direction of the second warp, with an interval provided between each two neighboring wefts, a first band provided in said long axis direction of the first warp, and a connecting device connected to the first warp and the first band. Two ends of each weft are respectively connected to the first and the second warps to rest a slat thereon. The first warp and the first band are relatively movable without interfering with each other, whereby to provide a good shielding effect when the slats are closed.

### BACKGROUND OF THE INVENTION

### 1. Technical Field

The present invention relates generally to a window blind, and more particularly to a composite ladder tape and a window blind with said composite ladder tape.

### 2. Description of Related Art

The structure of a window blind commonly includes a headrail, a bottom rail, and a plurality of slats horizontally arranged therebetween, wherein the headrail and the bottom rail are connected through ladder tapes. Each ladder tape includes two warps and a plurality of wefts, wherein the warps are respectively provided on the front and rear sides of the slats, with two ends thereof respectively connected to the headrail and the bottom rail. Two ends of each weft are respectively connected to one warp in a way that the wefts are arranged between two warps, with an interval provided between each two neighboring warps to allow one of the slats to rest thereon. When one of the warps is moved up and down relative to the other warp, the wefts tilt, so that the slats rest thereon are tilted as well. In this way, the slats can be rotated to a closed position.

Some window blinds further have wide bands provided between the headrail and the bottom rail. Such a band would have a certain width, and therefore is able to create a decorative effect. Furthermore, the through holes on the slats, the warps of the ladder tapes, and other control cords can be shielded by the bands, providing a beautiful and neat feeling. However, since the bands and the warps of the ladder tapes are made of different materials, they may have different extension rates. As a result, the relative positions of the bands and the warps tend to change after using for a long period of time. Moreover, even bands on different sides or ladder tapes on different sides may have inconsistent lengths depending on the habit preference of the user. In such a condition, the positions of the wefts which have slats rest thereon would be offset, which not only affects the degree of closure while closing the slats, but also causes wrinkles on the bands fixedly connected to the warps of the ladder tapes, for the relative positions of the bands and the ladder tapes are also changed, making the window blind less beautiful.

Thus, a conventional window blind may not look beautiful, and may not be able to provide good closure when the slats are closed.

### BRIEF SUMMARY OF THE INVENTION

In view of the above, the primary objective of the present invention is to provide a composite ladder tape and a window blind with said ladder tape, which could provide a good shielding effect when the slats are closed, and would look beautiful at the same time.

The present invention provides a composite ladder tape, including a first warp, a second warp, a plurality of wefts, a first band, and a connecting device. The second warp is parallel to and spaced apart from the first warp. The wefts are provided in a long axis direction of the first warp and a long axis direction of the second warp, with an interval provided between each two neighboring wefts, wherein two ends of each of the wefts are respectively connected to the first warp and the second warp. The first band is provided in the long axis direction of the first warp. The connecting device connects the first warp and the first band, wherein the first warp and the first band are movable relative to each other.

In an embodiment, the connecting device includes a cord member provided in a long axis direction of the first band. A plurality of silts are formed between the cord member and a surface of the first band, and the first warp passes through the slits.

In an embodiment, the cord member of the connecting device is a thread provided. The thread includes a plurality of first portions and a plurality of second portions, wherein the first portions and the second portions are respectively fixed on the first band, and are respectively located on two sides of the first warp. A segment of the thread between each of the first portions and the corresponding adjacent second portion forms a slit between said segment and the surface of the first band.

In an embodiment, the first portions are sewn into the first band, and each of the first portions has at least one first sewing point. The second portions are sewn into the first band, and each of the second portions has at least one second sewing point. The first warp is located between the first sewing points and the second sewing points.

In an embodiment, the cord member of the connecting device is composed of a plurality of first crossing threads, which are provided on the surface of the first band in the long axis direction thereof. An interval is provided between each two neighboring first crossing threads. One of the slits is formed between each of the first crossing threads and the surface of the first band.

In an embodiment, the cord member of the connecting device is composed of a plurality of second crossing threads, a plurality of fixing loops, and a fixing cord. The second crossing threads are provided on the first band in the long axis direction thereof, with an interval provided between each two neighboring second crossing threads. One of the slits is formed between each of the second crossing threads and the surface of the first band; the fixing loops are provided on the first warp in the long axis direction of the first band, with an interval provided between each two neighboring fixing loops. The fixing cord passes through the fixing loops and the slits.

In an embodiment, two ends of the fixing cord are respectively fixed on the first band.

In an embodiment, the first band is formed by interweaving a plurality of lengthwise yarns and a plurality of crosswise yarns. A part of the crosswise yarns is not interwoven with the lengthwise yarns, and constitutes said second crossing threads.

In an embodiment, the connecting device includes a plurality of buckles, which are provided on the first band in a long axis direction thereof. An interval is provided between each two neighboring buckles. Each of the buckles has a ring portion. The first warp passes through the ring portions of the buckles.

In an embodiment, a plurality of first loops are provided on the first warp, on the first band, or on the connecting device in a long axis direction of the first band, with an interval provided between each two neighboring first loops.

In an embodiment, a plurality of second loops are provided on the second warp near each of the weft in a long axis direction of the first band.

In an embodiment, a second band is further provided in the long axis direction of the second warp.

The present invention further provides a window blind, including a headrail, a bottom rail, a plurality of slats, at least one composite ladder tape, and at least one second cord. The slats are horizontally provided between the headrail and the bottom rail, wherein each of the slats has a through hole provided thereon. The at least one composite ladder tape connects the headrail and the bottom rail. The at least one second cord is adapted to raise and lower the window blind. Each of the at least one composite ladder tape includes a first warp, a second warp, a plurality of wefts, a first band, a connecting device, and a plurality of second loops. The second warp is spaced apart from the first warp, wherein the first and the second warps are respectively provided on a front side and a rear side of the slats. Two ends of the first warp and two ends of the second warp are respectively connected to the headrail and the bottom rail. The wefts are provided in a long axis direction of the first warp and a long axis direction of the second warp, with an interval provided between each two neighboring wefts, wherein two ends of each of the wefts are respectively connected to the first warp and the second warp. Each of the wefts has one of the slats resting thereon. The first band is provided in the long axis direction of the first warp. The connecting device connects the first warp and the first band, wherein the first warp and the first band are movable relative to each other. The second loops are provided on the second warp near each of the wefts in a long axis direction of the first band, wherein each of the second loops passes through one of the through holes of the slats, and the second cord passes through the second loops.

In an embodiment, the window blind further includes at least one first cord adapted to raise and lower the window blind, wherein a plurality of first loops are provided on the first warp, on the first band, or on the connecting device in the long axis direction of the first band, with an interval provided between each two neighboring first loops. The at least one first cord passes through the first loops.

In an embodiment, the connecting device includes a cord member provided in the long axis direction of the first band. A plurality of silts are formed between the cord member and a surface of the first band. The first warp passes through the slits.

In an embodiment, the cord member of the connecting device is a thread. The thread includes a plurality of first portions and a plurality of second portions, wherein the first portions and the second portions are respectively fixed on the first band, and are respectively located on two sides of the first warp. A segment of the thread between each of the first portions and the corresponding adjacent second portion forms one of the slits between said segment and the first band.

In an embodiment, the first portions are sewn into the first band, and each of the first portions has at least one first sewing point. The second portions are sewn into the first band, and each of the second portions has at least one second sewing point. The first warp is located between the first sewing points and the second sewing points.

In an embodiment, the cord member of the connecting device is composed of a plurality of first crossing threads, which are provided on the surface of the first band in the long axis direction thereof. An interval is provided between each two neighboring first crossing threads. One of the slits is formed between each of the first crossing threads and the surface of the first band.

In an embodiment, the cord member of the connecting device is composed of a plurality of second crossing threads, a plurality of fixing loops, and a fixing cord. The second crossing threads are provided on the first band in the long axis direction thereof, with an interval provided between each two neighboring second crossing threads. One of the slits is formed between each of the second crossing threads and the surface of the first band; the fixing loops are provided on the first warp in the long axis direction of the first band, with an interval provided between each two neighboring fixing loops. The fixing cord passes through the fixing loops and the slits.

In an embodiment, the window blind further includes at least one first cord adapted to raise and lower the window blind, wherein the at least one first cord passes through the fixing loops and the slits.

In an embodiment, two ends of the fixing cord are respectively fixed on the first band.

In an embodiment, wherein the connecting device includes a plurality of buckles, which are provided on the first band in the long axis direction thereof. An interval is provided between each two neighboring buckles. Each of the buckles has a ring portion. The first warp passes through the ring portions of the buckles.

In an embodiment, the window blind further includes a second band provided in the long axis direction of the second warp.

With the aforementioned design, the first band could effectively shield the first warp without hindering the movement of the first warp. As a result, the composite ladder tape could maintain a good shielding effect when the slats are closed. Furthermore, the bands would not be extensively pulled by the warps, and therefore fewer wrinkles would be created on the bands, making the bands look beautiful.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of window blind of a first embodiment of the present invention, which has the composite ladder tape;

FIG. 2 is a partial perspective view of the composite ladder tape of the first embodiment;

FIG. 3 is a top view along the 3-3 line in FIG. 2;

FIG. 4 is a partial perspective view of the composite ladder tape of a second embodiment;

FIG. 5 is a partial perspective view of the composite ladder tape of a third embodiment;

FIG. 6 is a partial perspective view of the composite ladder tape of a fourth embodiment;

FIG. 7 is a partial perspective view of the composite ladder tape of a fifth embodiment;

FIG. 8 is a partial perspective view of the composite ladder tape of a sixth embodiment;

FIG. 9 is a partial perspective view of the composite ladder tape of the sixth embodiment;

FIG. 10 is a partial perspective view of the composite ladder tape of an alternative embodiment;

FIG. 11 is a partial perspective view of the composite ladder tape of yet another alternative embodiment; and

FIG. 12 is a partial perspective view of the composite ladder tape of a seventh embodiment.

### DETAILED DESCRIPTION OF THE INVENTION

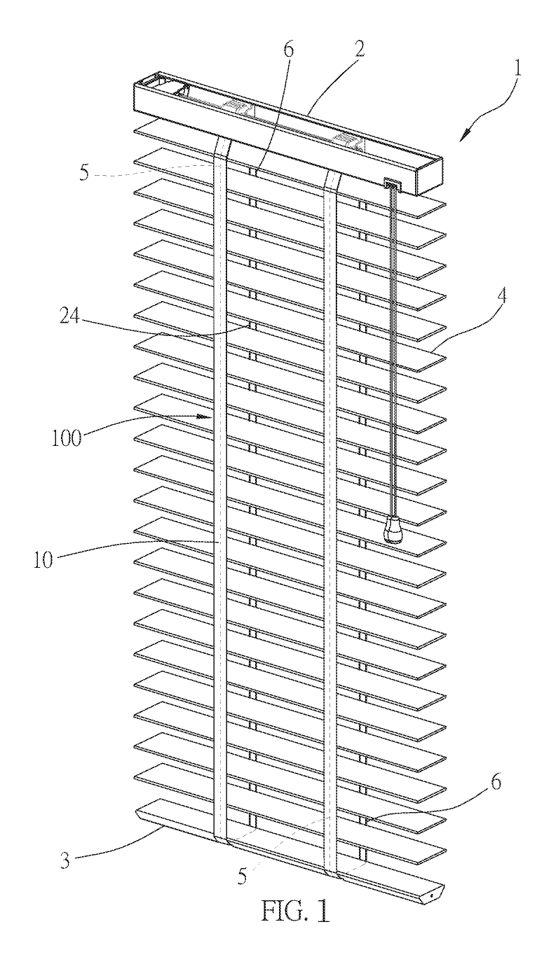

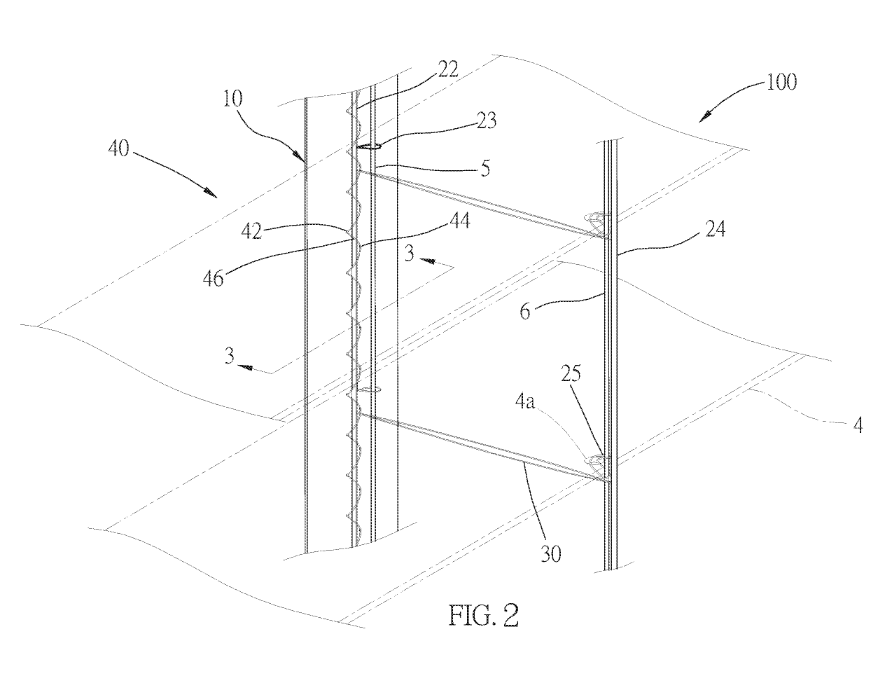

As shown in FIG. 1, the window blind 1 of the first embodiment of the present invention includes a composite ladder tape 100. Furthermore, the window blind 1 also includes a headrail 2, a bottom rail 3, a plurality of slats 4 provided between the headrail 2 and the bottom rail 3, at least one first cord 5, and at least one second cord 6, wherein the at least one first cord 5 and the at least one second cord 6 are respectively provided on a front side and a rear side of the slats 4. In addition, the at least one first cord 5 and the at least one second cord 6 are either connected to the bottom rail, or connected to each other in the bottom rail, forming a lifting cord which is adapted to raise or lower the window blind 1. As shown in FIG. 1 and FIG. 2, the composite ladder tape 100 in the first embodiment includes a first band 10, a first warp 22, a second warp 24, a plurality of wefts 30, and a connecting device.

The first band 10 has an appropriate width, and is provided in a long axis direction of the first warp 22. An end of the first band 10 is connected to the headrail 2, while another end thereof is connected to the bottom rail 3.

The first warp 22 and the second warp 24 are provided in parallel, and are both in parallel with a long axis direction of the first band 10 as well. The warps 22, 24 are respectively provided on the front side and the rear side of the slat 4, wherein two ends of each of the warps 22, 24 are respectively connected to the headrail 2 and the bottom rail 3.

The wefts 30 are provided between the first warp 22 and the second warp 24 with an interval provided between each two neighboring wefts 30, wherein two ends of each of the weft 30 are respectively connected to the first warp 22 and the second warp 24 to allow one of the slats 4 to rest thereon. In other words, the slats 4 are supported by the wefts 30.

The connecting device is connected to the first band 10, whereby the first warp 22 is connected to the first band 10, and the first warp 22 is movable relative to the first band 10. For example, the first warp 22 could move or slide relative to the first band 10 in the long axis direction of the first band 10.

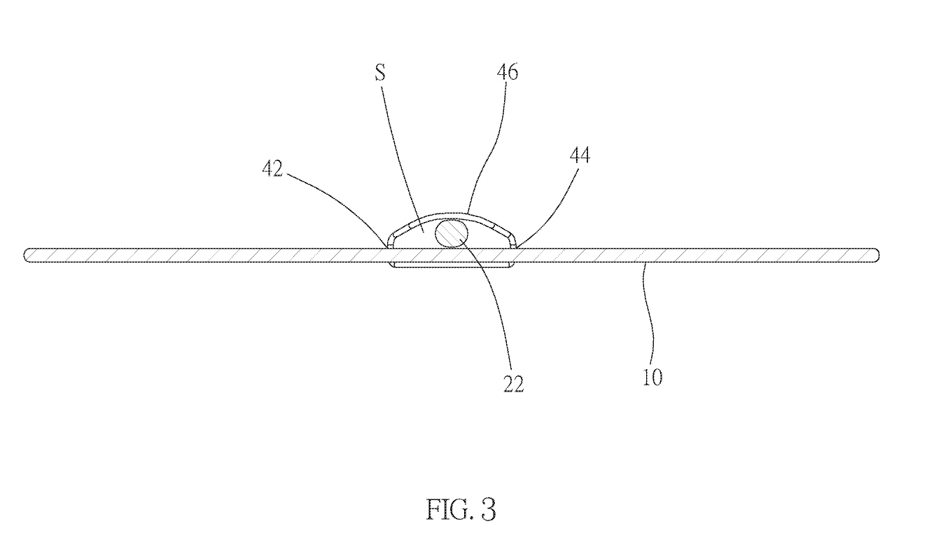

In the first embodiment, said connecting device includes a cord member, which is a thread 40 provided in the long axis direction of the first band 10, wherein the thread 40 includes a plurality of first portions 42 and a plurality of second portions 44. The first portions 42 and the second portions 44 are respectively fixed on the first band 10, which are respectively located on two sides of the first warp 22. The first portions 42 are sewn into the first band 10, each of which has a first sewing point thereon. Similarly, the second portions 44 are also sewn into the first band 10, each of which has a second sewing point thereon. As shown in FIG. 3, a segment 46 is defined on the thread 40 between each adjacent first portion 42 and second portion 44 (i.e., between each adjacent first sewing point and second sewing point), wherein a slit S is formed by each of the segments 46 and the first band 10. The first warp 22 passes through the slits S.

With the aforementioned design, the first band 10 could effectively shield the first warp 22 to create a decorative effect. Furthermore, with the design of the connecting device, the first warp 22 could be slightly movable in each of the slits S, so that the first warp 22 could move or slide relative to the long axis direction of the first band 10. In this way, when the slats 4 are tilted through the first warp 22 or the second warp 24 to adjust the shielding effect of the window blind 1, the movement of the first warp 22 would not affect the closure of the slats 4 even though the first warp 22 and the first band 10 may have different extension rates. Furthermore, the first band 10 would not be extensively pulled by the warps 22, 24 while in use. Therefore, the first band 10 would not have fewer wrinkles created thereon, and would look more beautiful.

In other embodiments, said cord member of the connecting device could be composed of more than one thread sewn on the first band 10, wherein each thread could be connected to another thread or not.

It is worth mentioning that, said composite ladder tape 100 could be further provided with a plurality of first loops and a plurality of second loops. For example, a plurality of first loops 23 could be provided on the first warp 22, on the first band 10, or on the thread 40 in the long axis direction of the first band 10, with an interval provided between each two neighboring first loops 23; a plurality of second loops 25 could be provided on the second warp 24 near each of the wefts 30 in the long axis direction of the first band 10, with an interval provided between each two neighboring second loops 25.

The first loops 23 are adapted to be passed through by the first cord 5, whereby the position and the movable range of the first cord 5 could be reasonably limited or positioned. Similarly, the second loops 25 are adapted to be passed through by the second cord 6, whereby the position and the movable range of the second cord 6 could be reasonably limited or positioned. Preferably, the first loops 23 and the second loops 25 could have excellent flexibility, so that they could perfectly match the corresponding cords 5, 6. However, the flexibility of the first loops 23 and the second loops 25 is not a limitation of the present invention. In practice, the first cord 5 and the second cord 6 could also provide different functions.

In another embodiment, a through hole 4a is provided on each of the slats 4 near a lateral edge thereof. A perimeter of each of the second loop 25 is greater than that of each of the first loop 23. Each of the second loops 25 respectively passes through the through hole 4a on one of the slats 4, and the second cord 6 passes through a part of each of the second loops 25 which extends out of the corresponding through hole 4a.

The aforementioned relation between the second loops 25 and the through holes 4a of the slats 4 could make the second warp 24, the slats 4, and the second cord 6 contain each other, restricting a lateral movable range of these components, whereby said components would not be easily disengaged from where they are, nor be excessively displaced. In addition, the advantages of providing the through holes 4a near the lateral edges of the slats 4 is that, when the window blind 1 is closed, each of the through holes 4a would be shielded by the overlapped part of the lateral edges of two neighboring slats 4, whereby the through holes 4a would not be exposed, enhancing the beauty and the degree of concealment of the window blind 1.

The positions of the first loops and the second loops mentioned in the above embodiment could be exchanged in another embodiment. In other words, there could be a plurality of second loops 25 provided on the first warp 22, on the first band 10, or on the thread 40 near each of the wefts 30 in the long axis direction of the first band 10, while a plurality of first loops 23 could be provided on the second warp 24 in the long axis direction of the first band 10, with an interval provided between each two neighboring first loops 23, wherein the first loops 23 are adapted to be passed through by the second cord 6. In such an embodiment, the perimeter of each of the first loops 23 is no greater than that of each of the second loops 25, and said through holes 4a could be also disposed at lateral edges of the slat 4 near the first warp 22. Whereby, the through holes 4a could be passed through by the second loops 25, and the second loops 25 could be passed through by the first cord 5. However, such design is not a limitation of the present invention.

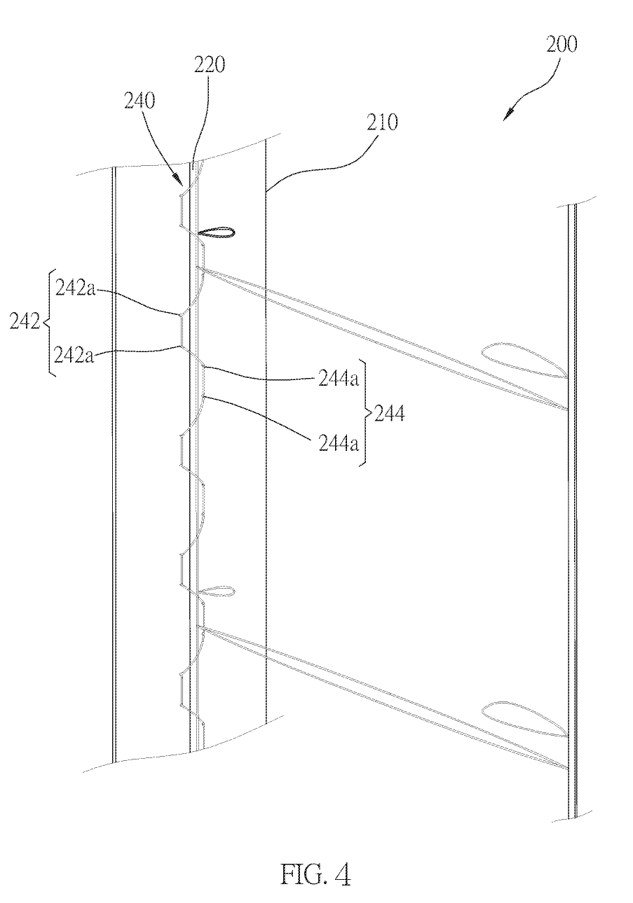

As shown in FIG. 4, a composite ladder tape 200 of the second embodiment of the present invention has roughly the same structure with the first embodiment, except that each first portion 242 of a thread 240 thereof has two first sewing points 242a, and each second portion 244 of the thread 240 has two second sewing points 244a, wherein the first sewing points 242a and the second sewing points 244a are sewn into a first band 210, and are respectively located on two sides of a first warp 220 of the composite ladder tape 200, so that the first warp 220 could move or slide relative to a long axis direction of the first band 210. The above design could further improve the strength of sewing between the thread 240 and the first band 210, which could lower the risk of having an unreliable connection between the thread 240 and the first band 210, and could enhance the durability of the window blind.

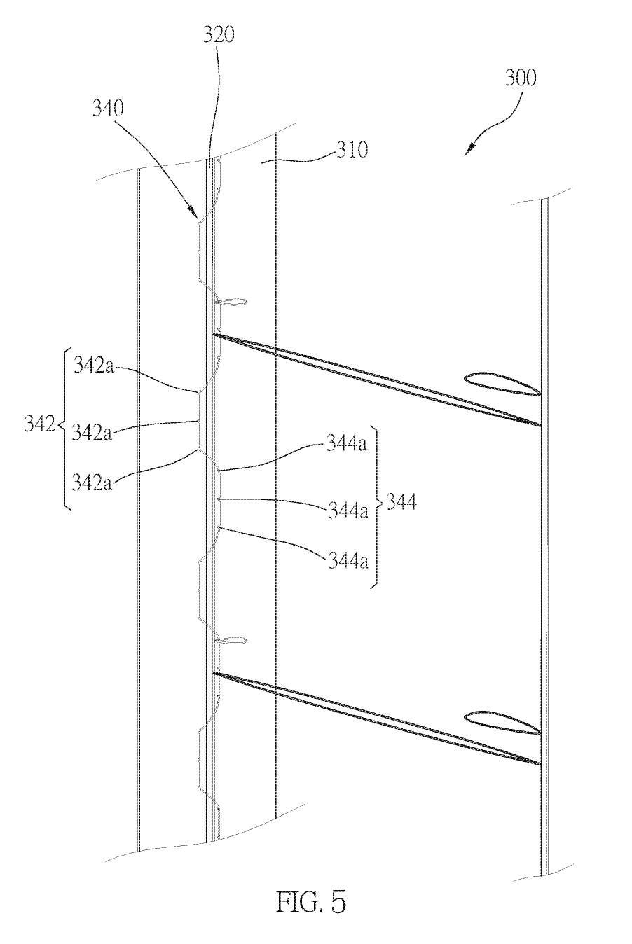

As shown in FIG. 5, a composite ladder tape 300 of the third embodiment of the present invention has roughly the same structure with the first and the second embodiments, except that a first portion 342 of a thread 340 thereof has three first sewing points 342a, and a second portion 344 of the thread 340 has three second sewing points 344a, wherein the first sewing points 342a and the second sewing points 344a are sewn into a first band 310, and are respectively located on two sides of a first warp 320 of the composite ladder tape 300, so that the first warp 320 could move or slide relative to a long axis direction of the first band 310. The above design could further improve the strength of sewing between the thread 340 and the first band 310, which could lower the risk of having an unreliable connection between the thread 340 and the first band 310, and could enhance the durability of the window blind.

It is worth mentioning that, though the number of the first sewing points of each first portion equals the number of the second sewing points of each second portion in the above embodiments, they are not necessary to be the same. For example, in another embodiment, it is possible that each first portion has only a first sewing point, while each second portion has a plurality of second sewing points, or the other way around. In yet another embodiment, the number of the first sewing points of each first portion could be further different from the number of the second sewing points of each second portion. However, the numbers of the first and the second sewing points, whether they are identical or not, are not limitations of the present invention.

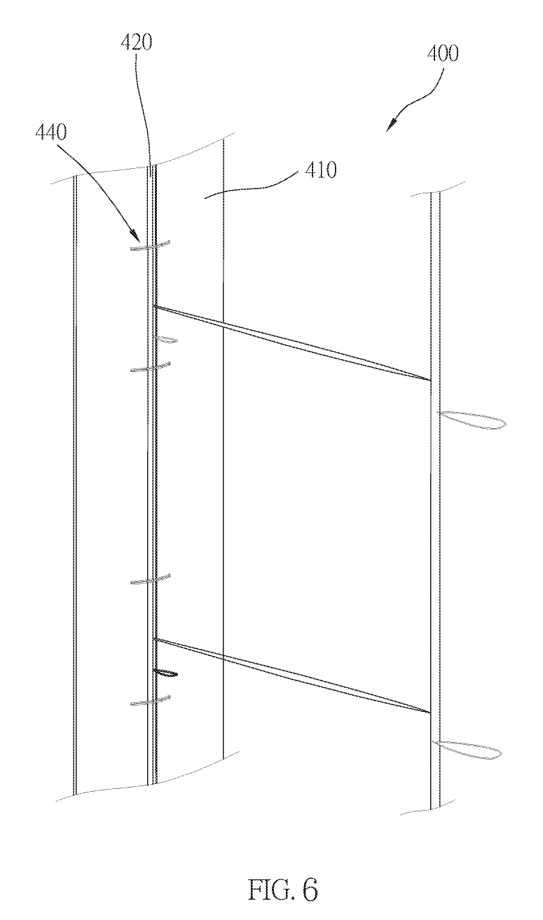

As shown in FIG. 6, a composite ladder tape 400 of the fourth embodiment of the present invention has roughly the same structure with the aforementioned embodiments, wherein the connecting device also includes a cord member, but the cord member is composed of a plurality of first crossing threads 440, which are provided on a surface of a first band 410 of the composite ladder tape 400 from top down in a long axis direction of the first band 410, wherein an interval is provided between each two neighboring first crossing threads 440. A slit is formed between each of the first crossing threads 440 and the surface of the first band 410, wherein a first warp 420 of the composite ladder tape 400 passes through the slits, and the first warp 420 and the first band 410 could move or slide relative to each other. Such design of said cord member could reduce the usage amount of the first crossing threads 440, which could lower the cost of manufacturing. Furthermore, the cord member would not interfere with the individual movements of the first band 410 and the first warp 420.

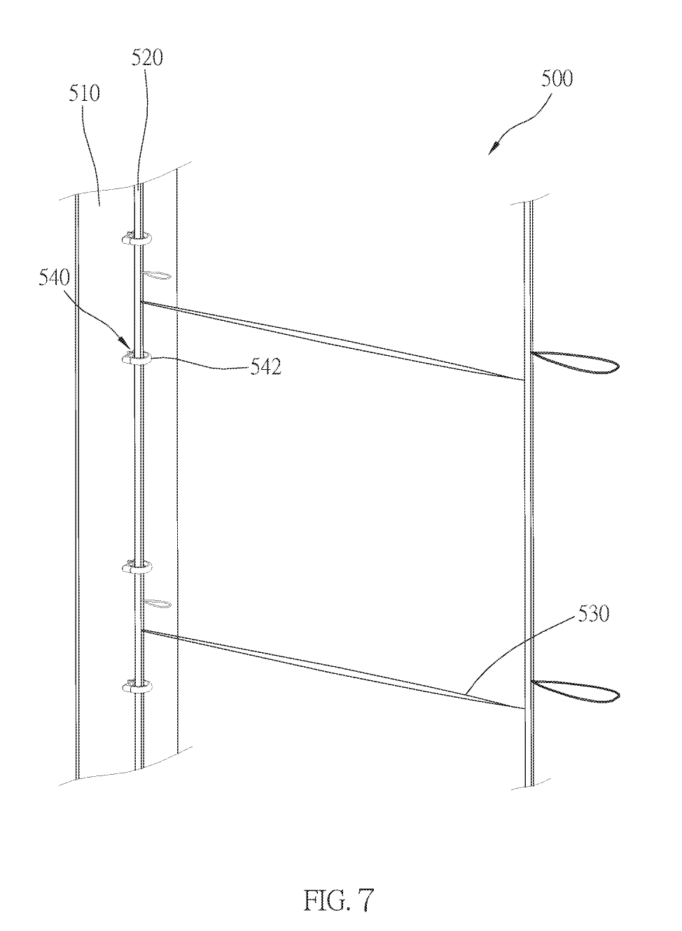

As shown in FIG. 7, a composite ladder tape 500 of the fifth embodiment of the present invention has roughly the same structure with the aforementioned embodiments, except that a connecting device thereof includes a plurality of buckles 540, which are provided on a first band 510 of the composite ladder tape 500 in a long axis direction of the first band 510, wherein an interval is provided between each two neighboring buckles 540. Each of the buckles has a ring portion 542, wherein a first warp 520 of the composite ladder tape 500 passes through the ring portions 542 of the buckles 540, whereby the first warp 520 could move or slide relative to a long axis direction of the first band 510. With the above design, the first warp 520 would be confined by the series of the buckles 540, and therefore would not easily form a loop when pulled outward, which reduces the risk that users might get hurt by being wound by the first warp 520. Furthermore, the connecting device would not interfere with the individual movements of the first band 510 and the first warp 520.

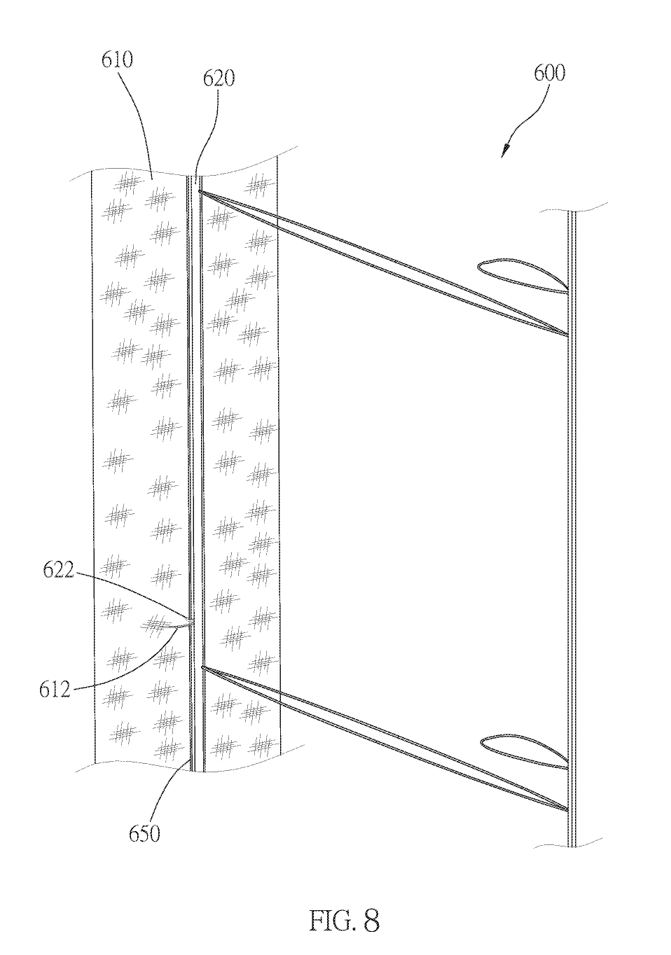

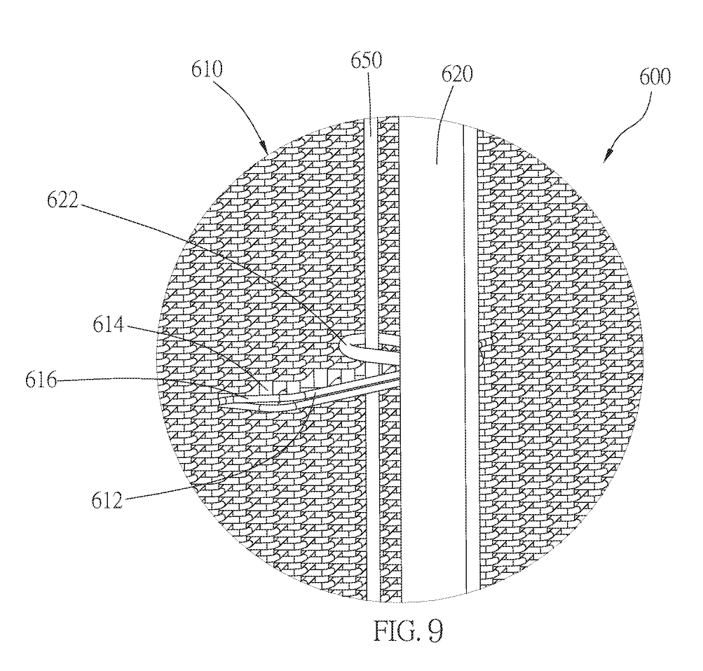

As shown in FIG. 8 and FIG. 9, a composite ladder tape 600 of the sixth embodiment of the present invention has roughly the same structure with the aforementioned embodiments, except that the composite ladder tape 600 further includes a plurality of second crossing threads 612 provided on a first band 610 from top down in a long axis direction of the first band 610, a plurality of fixing loops 622, and a fixing cord 650, wherein an interval is provided between each two neighboring second crossing threads 612, and a slit is formed between each of the second crossing threads 612 and a surface of the first band 610. In the sixth embodiment, the first band 610 is formed by interweaving a plurality of lengthwise yarns 614 and a plurality of crosswise yarns 616, wherein a part of the crosswise yarns 616 is not interwoven with the lengthwise yarns 614, and constitutes said second crossing threads 612. The fixing loops 622 are provided on the first warp 620 of the composite ladder tape 600, with an interval provided between each two neighboring fixing loops 622. Two ends of the fixing cord 650 are respectively connected to the first band 610, wherein the fixing cord 650 passes through the fixing loops 622 and the slits formed between the second crossing threads 612 and the surface of the first band 610 to connect the first warp 620 and the first band 610. By providing the fixing cord 650, the stability of the structure between the first warp 620 and the first band 610 could be enhanced, and the safety in use of the window blind could be improved as well. The fixing loops 622 could be the first loops 23 or the second loops 25 in the first embodiment which are adapted to be passed through by the first cord 5 or the second cord 6, and the fixing cord 650 could be the first cord 5 or the second cord 6. However, these are not the limitations of the present invention.

With the aforementioned design, the relative positions among the first band 610, the fixing cord 650, and the first warp 620 could be effectively confined, wherein the first warp 620 and the first band 610 could be moved relative to each other. As a result, when the first warp 620 is manipulated to adjust the tilt angle of the slats, the movement of the first warp 620 would not likely be restricted by the first band 610, whereby the slats could be perfectly closed. Furthermore, the first band 610 would not be excessively pulled by the warp 620, and therefore the first band 610 would not easily have unpleasant wrinkles created thereon. It is worth mentioning that, the design mentioned above could also prevent the first warp 620 and the fixing cord 650 from forming loops of different sizes when pulled outward.

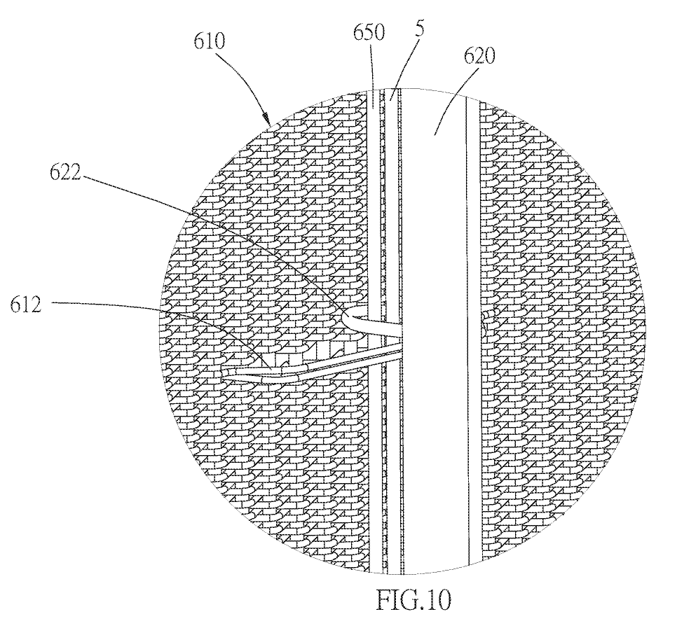

It is also worth mentioning that, in an alternative embodiment shown in FIG. 10, the first cord 5 of the window blind passes through the fixing loops 622 and the slits formed between the second crossing threads 612 and the surface of the first band 610. In other words, the fixing loops 622 and the slits are passed through by the fixing cord 650 and the first cord 5 at the same time to connect the first warp 620 and the first band 610.

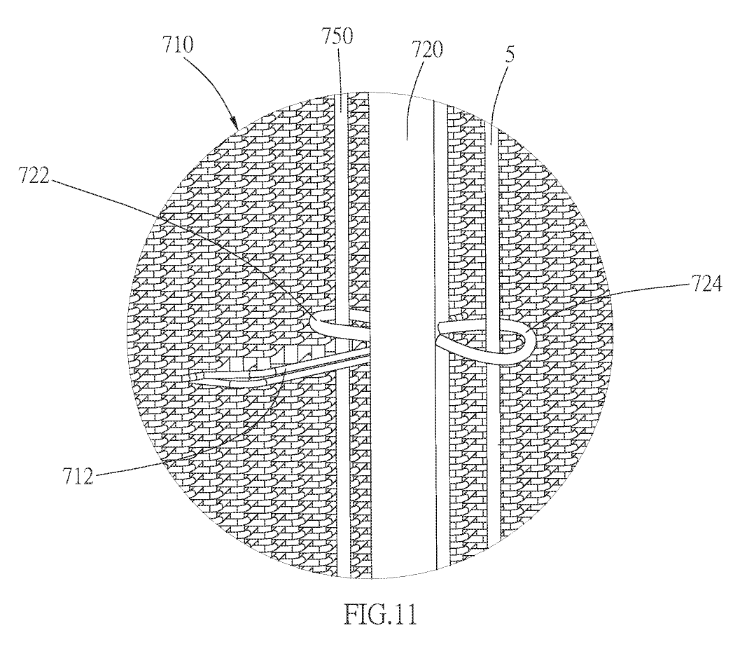

Furthermore, in addition to the above embodiment with the fixing cord 650 and the first cord 5 both pass through the fixing loops 622, yet another alternative embodiment of the present invention is shown in FIG. 11, which has roughly the same structure with the aforementioned embodiments, wherein the connecting device also includes a cord member, but the cord member is composed of a plurality of second crossing threads 712, a plurality of fixing loops 722, and a fixing cord 750, wherein the fixing loops 722 are provided on a first warp 720 in a long axis direction of a first band 710, with an interval provided between each two neighboring fixing loops 722; the second crossing threads 712 are provided in the long axis direction of the first band 710 from top down, with an interval provided between each two neighboring second crossing threads 712, wherein a slit is formed between each of the second crossing threads 712 and a surface of the first band 710; the fixing cord 750 passes through the fixing loops 722 on the first warp 720 and the slits formed between the second crossing threads 712 and the surface of the first band 710, whereby to connect the first warp 720 and the first band 710.

With the design of the fixing loops 722, the fixing cord 750, and the second crossing threads 712, the first warp 720 and the first band 710 would be connected together and still able to move or slide relative to each other. In addition, a plurality of first loops 724 are provided on the first warp 720 in a long axis direction of the first band 710, with an interval provided between each two neighboring first loops 724, and the first cord 5 passes through the first loops 724. Whereby, the first cord 5 could be connected to the first warp 720 in a way that the first cord 5 could be still movable relative to the first warp 720, so that the movable range of first cord 5 could be properly limited while being pulled, which ensures the safety of the user without interfering with the movements between the warps and the cords.

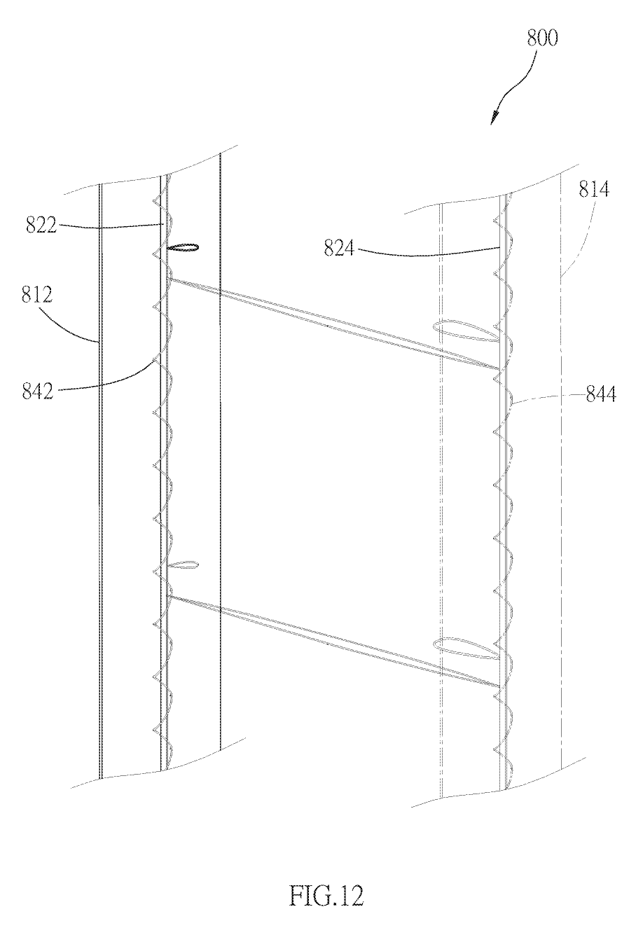

It is worth mentioning that, though there is only one single band exemplified in the aforementioned embodiments, this is not a limitation in practice. For example, as shown in FIG. 12, a composite ladder tape 800 of the seventh embodiment of the present invention is roughly the same with the composite ladder tape 100 of the above-mentioned first embodiment, except that the composite ladder tape 800 includes a first band 812 and a second band 814. The first band 812 is provided in a long axis direction of a first warp 822, wherein the first warp 822 and the first band 812 are connected as the connecting device (i.e., the thread 842) of the first embodiment, wherein the first warp 822 and the first band 812 are movable relative to each other. Similarly, the second band 814 is provided in a long axis direction of the second warp 824, wherein the second warp 824 and the second band 814 are connected as the connecting device (i.e., the thread 844) of the first embodiment, wherein the second warp 824 and the second band 814 are movable relative to each other. Widths of the first band 812 and the second band 814 could be either the same or different.

It is worth mentioning that, though the design of the bands (i.e., the first band 812 and the second band 814) of the composite ladder tape 800 of the aforementioned seventh embodiment is disclosed as mentioned above, in any embodiment which includes two or even more than two bands, both the connecting devices used to connect the first warp and the first band and used to connect the second warp and the second band could be carried out as any type of design disclosed in the first to the sixth embodiments.

Each composite ladder tape provided in the present invention could effectively shield the warp with the band to create a decorative effect. Furthermore, by connecting the band and the warp through the connecting device, the warp and the band would not interfere with each other while in use. Therefore, while adjusting or changing the shield effect created by the slats, the slats could be closed more perfectly. In addition, the band would not be easily pulled by the warp, whereby fewer wrinkles would be created on the band, which makes the window blind look more beautiful. It is also worth mentioning that, with the aforementioned design of the connecting device and the loops, the movable ranges of said warps and cords would be restricted while being pulled, which could reduce the risk that a user might get hurt by being wound by the warps or the cords.

It must be pointed out that the embodiments described above are only some preferred embodiments of the present invention. All equivalent structures which employ the concepts disclosed in this specification and the appended claims should fall within the scope of the present invention.

What is claimed is:

1. A composite ladder tape, comprising:
a first warp;
a second warp parallel to and spaced apart from the first warp;
a plurality of wefts provided in a long axis direction of the first warp and a long axis direction of the second warp, with an interval provided between each two neighboring wefts, wherein two ends of each of the wefts are respectively connected to the first warp and the second warp;
a first band provided in the long axis direction of the first warp; and
a connecting device, which connects the first warp and the first band, wherein the first warp and the first band are movable relative to each other.

2. The composite ladder tape of claim 1, wherein the connecting device comprises a cord member provided in a long axis direction of the first band; a plurality of silts are formed between the cord member and a surface of the first band; the first warp passes through the slits.

3. The composite ladder tape of claim 2, wherein the cord member of the connecting device is a thread, which comprises a plurality of first portions and a plurality of second portions, wherein the first portions and the second portions are respectively fixed on the first band, and are respectively located on two sides of the first warp; a segment of the thread between each of the first portions and the corresponding adjacent second portion forms one of the slits between said segment and the surface of the first band.

4. The composite ladder tape of claim 3, wherein the first portions are sewn into the first band, and each of the first portions has at least one first sewing point; the second portions are sewn into the first band, and each of the second portions has at least one second sewing point; the first warp is located between the first sewing points and the second sewing points.

5. The composite ladder tape of claim 2, wherein the cord member of the connecting device is composed of a plurality of first crossing threads, which are provided on the surface of the first band in the long axis direction thereof; an interval is provided between each two neighboring first crossing threads; one of the slits is formed between each of the first crossing threads and the surface of the first band.

6. The composite ladder tape of claim 2, wherein the cord member of the connecting device is composed of a plurality of second crossing threads, a plurality of fixing loops, and a fixing cord; the second crossing threads are provided on the first band in the long axis direction thereof, with an interval provided between each two neighboring second crossing threads; one of the slits is formed between each of the second crossing threads and the surface of the first band; the fixing loops are provided on the first warp in the long axis direction of the first band, with an interval provided between each two neighboring fixing loops; the fixing cord passes through the fixing loops and the slits.

7. The composite ladder tape of claim 6, wherein two ends of the fixing cord are respectively fixed on the first band.

8. The composite ladder tape of claim 6, wherein the first band is formed by interweaving a plurality of lengthwise yarns and a plurality of crosswise yarns; a part of the crosswise yarns is not interwoven with the lengthwise yarns, and constitutes said second crossing threads.

9. The composite ladder tape of claim 1, wherein the connecting device comprises a plurality of buckles, which are provided on the first band in a long axis direction thereof; an interval is provided between each two neighboring buckles; each of the buckles has a ring portion; the first warp passes through the ring portions of the buckles.

10. The composite ladder tape of claim 1, wherein a plurality of first loops are provided on the first warp, on the first band, or on the connecting device in a long axis direction of the first band, with an interval provided between each two neighboring first loops.

11. The composite ladder tape of claim 1, wherein a plurality of second loops are provided on the second warp near each of the wefts in a long axis direction of the first band.

12. The composite ladder tape of claim 1, further comprising a second band provided in the long axis direction of the second warp.

13. A window blind, comprising:
a headrail;
a bottom rail;
a plurality of slats horizontally provided between the headrail and the bottom rail, wherein each of the slats has a through hole provided thereon;
at least one composite ladder tape connecting the headrail and the bottom rail; and
at least one second cord adapted to raise and lower the window blind;
wherein each of the at least one composite ladder tape comprises:
a first warp;
a second warp spaced apart from the first warp, wherein the first and the second warps are respectively provided on a front side and a rear side of the slats; two ends of the first warp and two ends of the second warp are respectively connected to the headrail and the bottom rail;
a plurality of wefts provided in a long axis direction of the first warp and a long axis direction of the second warp, with an interval provided between each two neighboring wefts, wherein two ends of each of the wefts are respectively connected to the first warp and the second warp; each of the wefts has one of the slats resting thereon;
a first band provided in the long axis direction of the first warp;
a connecting device connecting the first warp and the first band, wherein the first warp and the first band are movable relative to each other; and
a plurality of second loops provided on the second warp near each of the wefts in a long axis direction of the first band, wherein each of the second loops passes through one of the through holes of the slats, and the second cord passes through the second loops.

14. The window blind of claim 13, further comprising at least one first cord adapted to raise and lower the window blind, wherein a plurality of first loops are provided on the first warp, on the first band, or on the connecting device in the long axis direction of the first band, with an interval provided between each two neighboring first loops; the at least one first cord passes through the first loops.

15. The composite ladder tape of claim 13, wherein the connecting device comprises a cord member provided in the long axis direction of the first band; a plurality of silts are formed between the cord member and a surface of the first band; the first warp passes through the slits.

16. The window blind of claim 15, wherein the cord member of the connecting device is a thread, which comprises a plurality of first portions and a plurality of second portions, wherein the first portions and the second portions are respectively fixed on the first band, and are respectively located on two sides of the first warp; a segment of the thread between each of the first portions and the corresponding adjacent second portion forms one of the slits between said segment and the surface of the first band.

17. The window blind of claim 16, wherein the first portions are sewn into the first band, and each of the first portions has at least one first sewing point; the second portions are sewn into the first band, and each of the second portions has at least one second sewing point; the first warp is located between the first sewing points and the second sewing points.

18. The window blind of claim 15, wherein the cord member of the connecting device is composed of a plurality of first crossing threads, which are provided on the surface of the first band in the long axis direction thereof; an interval is provided between each two neighboring first crossing threads; one of the slits is formed between each of the first crossing threads and the surface of the first band.

19. The window blind of claim 15, wherein the cord member of the connecting device is composed of a plurality of second crossing threads, a plurality of fixing loops, and a fixing cord; the second crossing threads are provided on the first band in the long axis direction thereof, with an interval provided between each two neighboring second crossing threads; one of the slits is formed between each of the second crossing threads and the surface of the first band; the fixing loops are provided on the first warp in the long axis direction of the first band, with an interval provided between each two neighboring fixing loops; the fixing cord passes through the fixing loops and the slits.

20. The window blind of claim 19, further comprising at least one first cord adapted to raise and lower the window blind, wherein the at least one first cord passes through the fixing loops and the slits.

21. The window blind of claim 19, wherein two ends of the fixing cord are respectively fixed on the first band.

22. The window blind of claim 13, wherein the connecting device comprises a plurality of buckles, which are provided on the first band in the long axis direction thereof; an interval is provided between each two neighboring buckles; each of the buckles has a ring portion; the first warp passes through the ring portions of the buckles.

23. The window blind of claim 13, further comprising a second band provided in the long axis direction of the second warp.
